(19) United States
(12) Patent Application Publication
(10) Pub. No.: US 2008/0064546 A1
(43) Pub. Date: Mar. 13, 2008

(54) Hydraulic Chain Tensioner with Reduced Piston Pressure

(76) Inventor: Thomas Ullein, Frensdorf (DE)

Correspondence Address: HEDMAN & COSTIGAN P.C., 1185 AVENUE OF THE AMERICAS, NEW YORK, NY, 10036, US

(21) Appl. No.: 11/662,113

(22) PCT Filed: Aug. 11, 2005
(86) PCT No.: PCT/EP05/08711

§ 371 Date: Mar. 6, 2007

(30) Foreign Application Priority Data
Sep. 10, 2004 (DE) 10 2004 043 727.0

(51) Int. Cl. F16H 7/08

(52) U.S. Cl. 474/110

(57) ABSTRACT

A hydraulic chain tensioner, whose high-pressure chamber receiving a chain tensioner piston mounted counter to a spring is connected to an oil supply chamber of the tensioner, which communicates with the oil gallery of the engine, wherein in the oil supply to the chain tensioner, particularly in the wall of the oil supply chamber, a pressure relief valve is installed, the opening pressure of which is matched to the desired supply pressure of the tensioner.

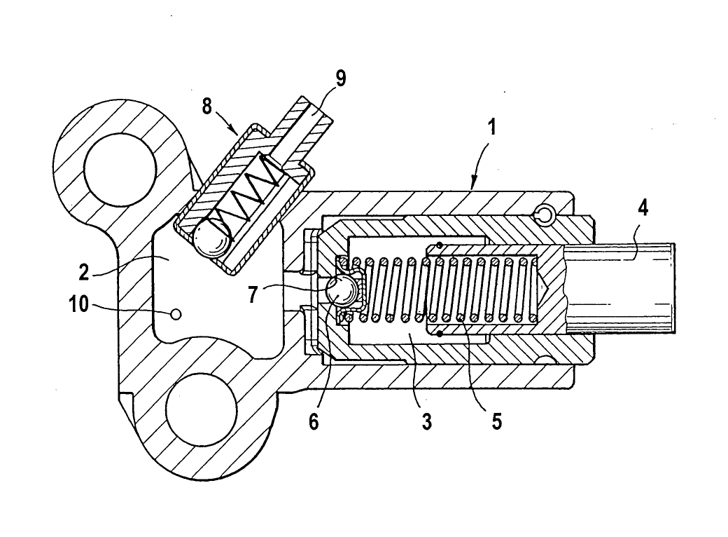

### FIELD OF THE INVENTION

The invention relates to a hydraulic chain tensioner, whose high-pressure chamber receiving a chain tensioner piston mounted counter to a spring is connected to an oil supply chamber of the tensioner, which communicates with the oil gallery of the engine.

### BACKGROUND TO THE INVENTION

The partially high supply pressures, specifically with a cold engine or at high rev speeds, with which the chain tensioners are usually provided, act upon the chain tensioner piston and lead to an increased pretensioning force of the chain tensioner piston and thus to higher average chain forces. Consequently, not only is there an increase in drive friction and an impairment of the noise characteristics, but the wear characteristics are also made worse.

As the configuration of the chains increasingly becomes ever more filigree, these abovementioned problems have even greater bearing, above all an increased chain lengthening also then being additionally observed.

Although it has already been proposed to limit the pressure in the oil gallery of the engine to a maximal value by the use of a valve, this value for the chain tensioner is still very high, since the usual pressures in the oil gallery are in the order of magnitude of 5 bar, whereas as little as 0.5 bar would suffice to ensure the functioning of the chain tensioner.

### SUMMARY OF THE INVENTION

The object of the invention is therefore to design a hydraulic chain tensioner of the type stated in the introduction such that, with a simple and operationally reliable construction, a uniform reduced pretensioning of the chain tensioner piston is achieved.

For the achievement of this object, it is provided according to the invention that in the wall of the oil supply chamber of the tensioner a pressure relief valve is installed, the opening pressure of which is matched to the desired supply pressure of the tensioner.

As a result of this lowering and maintenance of the oil pressure in the oil supply chamber of the tensioner to and at a value which is below the high oil pressure in the oil gallery of the engine, a correspondingly lower oil pressure is also obtained in the pressure chamber of the piston, so that it is possible to operate with a reduced chain tension.

Particularly advantageously, the pressure relief valve is here configured and arranged such that the outflowing lubrication oil jet is directed at the chain, so that, with no additional special effort—oil spray nozzles for lubrication of the chain were already previously known, but were not able to be used as defined in the present invention—two goals can be reached with one and the same arrangement, namely the lowering of the oil supply pressure of the chain tensioner to a lower constant pressure and the lubrication of the chain.

Finally, it also lies within the scope of the invention to install a throttle in the connecting line between the oil gallery of the engine and the oil supply chamber of the tensioner, in which case it is ultimately immaterial whether the throttle is provided on the engine side or is fitted to the tensioner housing. The effect of the throttle is that the functioning of the pressure relief valve according to the invention is not counteracted by an excessive supply of oil from the oil gallery of the engine and ultimately made inoperative.

### BRIEF DESCRIPTION OF THE DRAWINGS

Further advantages, features and details of the invention emerge from the following description of an illustrative embodiment and with reference to the drawing, which shows a section through a hydraulic chain tensioner according to the invention.

### DETAILED DESCRIPTION OF THE DRAWINGS

The chain tensioner housing 1 contains an oil supply chamber 2, which is connected to the high-pressure chamber 3 in which the chain tensioner piston 4, additionally pretensioned by a helical compression spring 5, is mounted. When the chain tensioner piston 4 is compressed due to an increase in tension in a chain drive, the oil in the high-pressure chamber 3 primarily serves as a cushioning element, since the spring 5 is not strong enough for the purpose. The outflowing of oil from the high-pressure chamber 3 into the oil supply chamber 2 is prevented by the ball valve 6 with valve seat 7. According to the invention, the oil supply chamber is provided with a pressure relief valve 8, which passes through the wall of the oil supply chamber 2 and is provided with an oil bore 9 configured as an oil spray nozzle and arranged such that it serves to lubricate the chain (not shown), which latter is hydraulically tensioned by means of the chain tensioner piston 4.

At 10, a throttle connection to the oil gallery of the engine is indicated diagrammatically, i.e. a throttle is installed either on the tensioner housing 1, or else on the engine, or in an intermediate connecting line, which throttle prevents too strong an influx of oil from the oil gallery of the engine into the oil supply chamber 2 in order to ensure that the functioning of the pressure relief valve is not impeded by too strong an afterflow of oil.

### REFERENCE NUMERALS

1 chain tensioner housing

2 oil supply chamber

3 high-pressure chamber

4 chain tensioner piston

5 helical compression spring

6 ball valve

7 valve seat

8 pressure relief valve

9 oil bore

10 throttle connection

1. A hydraulic chain tensioner, whose high-pressure chamber receiving a chain tensioner piston mounted counter to a spring is connected to an oil supply chamber of the tensioner, which communicates with the oil gallery of the engine, wherein in the oil supply to the chain tensioner, a pressure relief valve is installed, the opening pressure of the tensioner.

2. The chain tensioner of claim 1, wherein the pressure relief valve is configured and arranged such that the outflowing lubrification oil jet is directed at the chain.

3. The chain tensioner of claim 1, wherein a throttle is installed in the connecting line between the oil gallery of the engine and the oil supply chamber of the tensioner.

4. The chain tensioner of claim 1 wherein the pressure relief valve is installed in the wall of the oil supply chamber.

5. The chain tensioner of claim 2, wherein a throttle is installed in the connecting line between the oil gallery of the engine and the oil supply chamber of the tensioner.
